(19) United States
(12) Patent Application Publication
(10) Pub. No.: US 2024/0304368 A1
(43) Pub. Date: Sep. 12, 2024

(54) SUPERCONDUCTING MAGNET DEVICE

(71) Applicant: SUMITOMO HEAVY INDUSTRIES, LTD., Tokyo (JP)

(72) Inventor: Yuta EBARA, Yokosuka-shi, Kanagawa (JP)

(73) Assignee: SUMITOMO HEAVY INDUSTRIES, LTD., Tokyo (JP)

(21) Appl. No.: 18/597,958

(22) Filed: Mar. 7, 2024

(30) Foreign Application Priority Data
Mar. 9, 2023 (JP) 2023-036502

(51) Int. Cl. H01F 6/04; H01F 6/02; H01F 6/06

(52) U.S. Cl. CPC H01F 6/04; H01F 6/02; H01F 6/06

(57) ABSTRACT

A superconducting magnet device includes a superconducting coil, and a Joule heat generating element that is connected in parallel to the superconducting coil and is cooled to a cooling temperature higher than the superconducting coil during an operation of the superconducting coil.

### CROSS-REFERENCE TO RELATED APPLICATIONS

This application claims priority to Japanese Patent Application No. 2023-036502, filed on Mar. 9, 2023, which is incorporated by reference herein in its entirety.

### BACKGROUND

### Technical Field

A certain embodiment of the present invention relates to a superconducting magnet device.

### Description of Related Art

An undesired phenomenon that may occur during the operation of the superconducting magnet device is thermal runaway (quenching) of the superconducting coil. When quenching occurs, the superconducting coil transitions from the superconducting state to the normal conducting state, and resistance is generated inside the coil. A large Joule heat can be generated from a large current flowing through the coil in the superconducting state up to that point. An increase in voltage within the coil and the resulting discharge may also occur. In addition, a large electromagnetic force can act on the superconducting coil due to the transient current unbalance when quenching occurs. An eddy current is also generated in a conductor disposed in the vicinity of the coil, and an electromagnetic force can act on the conductor. The heat, discharge, and electromagnetic force that can be generated in this manner can damage the superconducting coil and surrounding structures and devices.

Generally, the superconducting magnet device is provided with a protection circuit for protecting the superconducting coil when quenching occurs. As an example of the protection circuit, there is a type having a diode connected in parallel with the superconducting coil. The protection circuit is usually disposed in a cryogenic environment together with the superconducting coil and cooled to the same temperature.

### SUMMARY

According to an aspect of the present invention, a superconducting magnet device includes a superconducting coil, and a Joule heat generating element that is connected in parallel to the superconducting coil and is cooled to a cooling temperature higher than the superconducting coil during an operation of the superconducting coil.

### BRIEF DESCRIPTION OF THE DRAWINGS

FIG. 1 is a diagram schematically showing a superconducting magnet device according to an embodiment.

FIG. 2 is a diagram schematically showing a superconducting magnet device according to a modification example.

FIG. 3 is a diagram schematically showing a superconducting magnet device according to a comparative example.

### DETAILED DESCRIPTION

When quenching occurs, the temperatures of the superconducting coil and the protection circuit rise. In order to recover the superconducting coil from the quenching and to operate the superconducting coil again, it is necessary to recool the superconducting coil and the protection circuit.

It is desirable to shorten the time required to recover the superconducting magnet device from quenching.

Hereinafter, embodiments for carrying out the present invention will be described in detail with reference to the drawings. In the description and drawings, identical or equivalent components, members, and processing are denoted by the same reference numerals, and overlapping description is omitted as appropriate. The scale or shape of each part that is shown in the drawings is conveniently set for ease of description and is not limitedly interpreted unless otherwise specified. The embodiments are exemplary and do not limit the scope of the present invention in any way. All features or combinations thereof described in the embodiments are not necessarily essential to the invention.

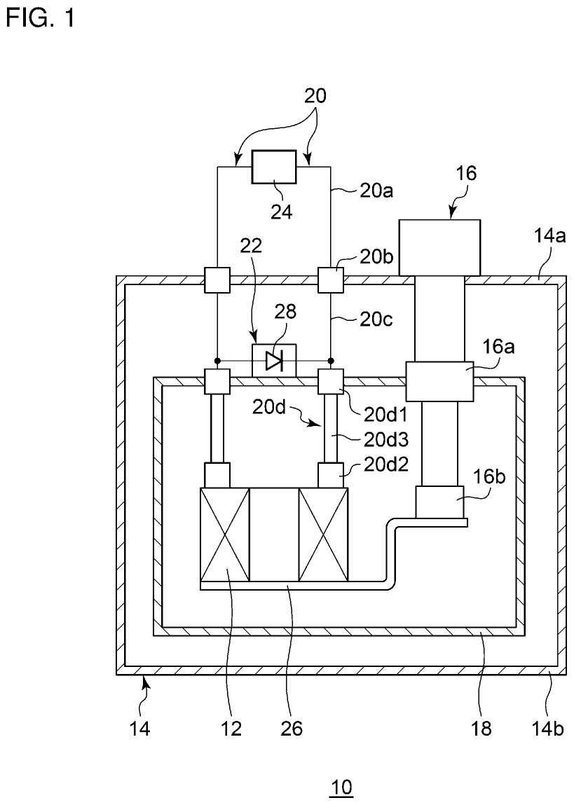

FIG. 1 is a diagram schematically showing a superconducting magnet device 10 according to an embodiment. The superconducting magnet device 10 can be mounted on a high-magnetic field utilization device as a magnetic field source of, for example, a single crystal pulling device, a nuclear magnetic resonance (NMR) system, a magnetic resonance imaging (MRI) system, an accelerator such as a cyclotron, a high energy physical system such as a nuclear fusion system, or other high-magnetic field utilization devices (not shown) and can generate a high magnetic field required for the device.

The superconducting magnet device 10 includes a superconducting coil 12, a vacuum chamber 14, a cryocooler 16, a heat shield 18, an electric current introduction line 20, and a Joule heat generating element 22.

The superconducting coil 12 is disposed inside the vacuum chamber 14, and is configured to generate a strong magnetic field by being energized in a state of being cooled to a cryogenic temperature equal to or lower than the superconducting transition temperature. The superconducting coil 12 may be a known superconducting coil (for example, a so-called low temperature superconducting coil). The superconducting coil 12 is connected to an external power supply 24 disposed outside the vacuum chamber 14 via the electric current introduction line 20. An exciting current is supplied from the external power supply 24 to the superconducting coil 12 through the electric current introduction line 20. In this way, the superconducting magnet device 10 can generate a strong magnetic field.

The vacuum chamber 14 is an adiabatic vacuum chamber that provides a cryogenic vacuum environment suitable for bringing the superconducting coil 12 into a superconducting state, and is also called a cryostat. Typically, the vacuum chamber 14 has a columnar shape or a cylindrical shape with a hollow portion in a central portion thereof. Therefore, the vacuum chamber 14 includes substantially flat circular or annular top plate 14a and bottom plate 14b, and a cylindrical side wall (cylindrical outer peripheral wall, or coaxially disposed cylindrical outer peripheral wall and inner peripheral wall) connecting the top plate 14a and the bottom plate 14b. The cryocooler 16 may be installed on the top plate 14a of the vacuum chamber 14. The vacuum chamber 14 is formed of, for example, a metal material such as stainless steel or other suitable high-strength materials to withstand an ambient pressure (for example, atmospheric pressure).

The cryocooler 16 is configured to cool the heat shield 18 and the Joule heat generating element 22 to a first cooling temperature, and cool the superconducting coil 12 to a second cooling temperature lower than the first cooling temperature. In this embodiment, the cryocooler 16 is a two-stage Gifford-McMahon (GM) cryocooler, and includes a first cooling stage 16a and a second cooling stage 16b. The first cooling stage 16a and the second cooling stage 16b are provided so as to surround the first expansion space and the second expansion space in the cryocooler 16, respectively, and are formed of a metal material such as copper or another material having a high thermal conductivity. The first cooling temperature may be in a temperature range of about 20K to about 100K, for example, a temperature range of about 30K to about 50K, and the second cooling temperature may be in a temperature range of about 3K to about 20K, for example, about 4K.

The heat shield 18 is disposed so as to surround the superconducting coil 12 within the vacuum chamber 14. The heat shield 18 is formed of, for example, a metal material such as copper or another material having a high thermal conductivity. The heat shield 18 is directly attached to the first cooling stage 16a of the cryocooler 16, and is thermally coupled to the first cooling stage 16a. Alternatively, the heat shield 18 may be attached to the first cooling stage 16a via a heat transfer member having flexibility or stiffness. During the operation of the superconducting magnet device 10, the heat shield 18 is cooled to a first cooling temperature by the first cooling stage 16a. The heat shield 18 can thermally protect low-temperature portions such as the second cooling stage 16b of the cryocooler 16 and the superconducting coil 12 which are disposed inside the heat shield 18 and are cooled to a lower temperature than the heat shield 18, from radiant heat from the vacuum chamber 14.

The superconducting coil 12 is thermally coupled to the second cooling stage 16b via the heat transfer member 26. The heat transfer member 26 is formed of, for example, a metal material such as copper or another material having a high thermal conductivity, and connects the superconducting coil 12 to the second cooling stage 16b. The heat transfer member 26 may be a rigid member that rigidly connects the superconducting coil 12 and the second cooling stage 16b, or may flexibly connect the superconducting coil 12 and the second cooling stage 16b to allow relative displacement between them. Alternatively, the superconducting coil 12 may be directly attached to the second cooling stage 16b and thermally coupled to the second cooling stage 16b. During the operation of the superconducting magnet device 10, the superconducting coil 12 is cooled to a second cooling temperature by the second cooling stage 16b.

The electric current introduction line 20 includes an external wire 20a, a feedthrough portion 20b, an outer current lead portion 20c, and an inner current lead portion 20d, and forms an electric current path from the external power supply 24 to the superconducting coil 12. Typically, one electric current introduction line 20 on the positive electrode side and one electric current introduction line 20 on the negative electrode side are provided.

The external wire 20a disposed outside the vacuum chamber 14 connects the external power supply 24 to the feedthrough portion 20b provided in a wall portion of the vacuum chamber 14. The external wire 20a may be an appropriate power supply cable. The feedthrough portion 20b is an airtight terminal for introducing a current into the vacuum chamber 14, and connects the external wire 20a to an internal wire (that is, the outer current lead portion 20c and the inner current lead portion 20d) in the vacuum chamber 14. The electric current introduction line 20 can penetrate the wall portion of the vacuum chamber 14 while maintaining the airtightness of the vacuum chamber 14 by means of the feedthrough portion 20b.

The outer current lead portion 20c is disposed outside the heat shield 18 within the vacuum chamber 14 and connects the feedthrough portion 20b to the inner current lead portion 20d. The outer current lead portion 20c is formed of, for example, a metal material having excellent conductivity and represented by pure copper such as oxygen-free copper. An end portion of the outer current lead portion 20c connected to the inner current lead portion 20d is thermally coupled to the heat shield 18. The end portion of the outer current lead portion 20c is fixed to the heat shield 18 or is connected to the heat shield 18 through an appropriate heat transfer member to be cooled to the first cooling temperature, similar to the heat shield 18. However, the outer current lead portion 20c is in a state of being electrically insulated from the heat shield 18. For example, the outer current lead portion 20c may be attached to the fixation portion such as the heat shield 18 or the heat transfer member by such that an insulating material (for example, a sheet of an insulating resin material) being interposed between the outer current lead portion 20c and the fixation portion.

The inner current lead portion 20d is disposed inside the heat shield 18 and connects the outer current lead portion 20c to the superconducting coil 12. The inner current lead portion 20d may include a first terminal 20d1, a second terminal 20d2, and a high-temperature superconducting current lead 20d3 connecting these two terminals. The first terminal 20d1 is connected to the outer current lead portion 20c, and the second terminal 20d2 is connected to the superconducting coil 12. The first terminal 20d1 is thermally coupled to the heat shield 18, and is cooled to the first cooling temperature similarly to the heat shield 18. The second terminal 20d2 is cooled to a second cooling temperature similarly to the superconducting coil 12.

The high-temperature superconducting current lead 20d3 may be formed of, for example, a copper oxide superconductor or other high-temperature superconducting material. The material of such a high-temperature superconducting current lead has thermal insulation properties. Therefore, compared to a case where the inner current lead portion 20d is made of metal, it is possible to reduce the heat that can be transferred from the Joule heat generating element 22 to the superconducting coil 12 by using the inner current lead portion 20d as a heat transfer path. This reduces the heat load on the second cooling stage 16b of the cryocooler 16 and can contribute to good cooling of the superconducting coil 12.

The Joule heat generating element 22 is connected in parallel to the superconducting coil 12. The Joule heat generating element 22 has one end connected to the electric current introduction line 20 on one side (for example, the positive electrode side) and the other end connected to the electric current introduction line 20 on the other side (for example, the negative electrode side), whereby the Joule heat generating element 22 is connected in parallel to the superconducting coil 12. For example, the Joule heat generating element 22 may be connected to the electric current introduction line 20 by using a busbar formed of a metal material having excellent conductivity such as copper.

The Joule heat generating element 22 can generate heat when energized, and may include a general linear resistance element (that is, according to Ohm's law), or may include a non-linear resistor. The non-linear resistor may have a non-linear characteristic in which the resistance value is high when the voltage applied to the non-linear resistor is small and the resistance value is low when the voltage applied to the non-linear resistor is large (the non-linear resistor may have a first resistance value when the voltage applied to the non-linear resistor is a first value, and have a second resistance value that is less than the first resistance value when the voltage applied to the non-linear resistor is a second value that is greater than the first value).

The non-linear resistor may be, for example, a rectifying element such as a diode or a thyristor. In this embodiment, the Joule heat generating element 22 includes a diode 28 as an example. Alternatively, the non-linear resistor may be a varistor. The Joule heat generating element 22 may include both a linear resistor and a non-linear resistor, and for example, these may be connected in series.

Unlike in the existing design in which the protection circuit of the superconducting coil is cooled to the same temperature as the superconducting coil, in this embodiment, the Joule heat generating element 22 is cooled to a cooling temperature higher than that of the superconducting coil 12 during the operation of the superconducting coil 12. The Joule heat generating element 22 may be thermally coupled to the first cooling stage 16a of the cryocooler 16 and cooled to a first cooling temperature. As shown in the illustrated example, the Joule heat generating element 22 may be connected between the outer current lead portions 20c, and may be installed at a portion cooled to the first cooling temperature, for example, the heat shield 18. The Joule heat generating element 22 may be connected to the superconducting coil 12 via the inner current lead portion 20d (that is, the high-temperature superconducting current lead 20d3).

In addition, the superconducting magnet device 10 may have a plurality of superconducting coils 12, and in this case, the Joule heat generating element 22 may be provided for each superconducting coil 12. The Joule heat generating element 22 corresponding to each of the plurality of superconducting coils 12 may be connected in parallel.

When quenching occurs during the operation of the superconducting coil 12, a voltage generated in the superconducting coil 12 is also applied to the Joule heat generating element 22. At this time, a current can flow from the superconducting coil 12 to the Joule heat generating element 22, and at least a part of the electromagnetic energy stored in the superconducting coil 12 can be converted into heat by the Joule heat generating element 22 and consumed. In this way, energy is extracted from the superconducting coil 12 by the Joule heat generating element 22, whereby the superconducting coil 12 can be protected when quenching occurs. Since the energy of the superconducting coil 12 is reduced, it is possible to prevent or reduce damage to the superconducting coil 12 and the periphery thereof which may be caused by the reduction.

When the temperature rise of the superconducting coil 12 accompanying the quenching is large, the time required for recooling for recovery is extended, that is, the downtime of the superconducting magnet device 10 can be increased. In this embodiment, since the Joule heat generating element 22 is cooled to a cooling temperature higher than that of the superconducting coil 12, compared to the existing design in which such a protection circuit is cooled to the same temperature (that is, a second cooling temperature) as the superconducting coil, recooling can be performed in a shorter time. It is possible to shorten the time required to recover the superconducting magnet device 10 from quenching.

Since the Joule heat generating element 22 is cooled by the first cooling stage 16a of the cryocooler 16, the heat generated by the Joule heat generating element 22 can be efficiently removed. This is because, in general, the cooling capacity of the first stage of the cryocooler 16 is larger than that of the second stage (for example, several tens of times), and there is a relatively large margin. This is also advantageous in shortening the time required to recover the superconducting magnet device 10 from quenching.

When the Joule heat generating element 22 is connected to the superconducting coil 12 via the high-temperature superconducting current lead 20d3, compared to a case where the inner current lead portion 20d is made of metal, it is possible to reduce the heat that can be transferred from the Joule heat generating element 22 to the superconducting coil 12 by using the inner current lead portion 20d as a heat transfer path. This reduces the heat load on the second cooling stage 16b of the cryocooler 16 and can contribute to good cooling of the superconducting coil 12.

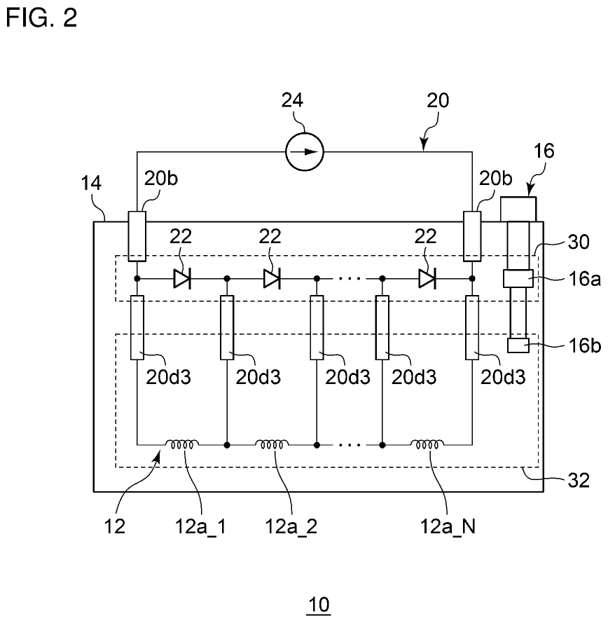

FIG. 2 is a diagram schematically showing a superconducting magnet device 10 according to a modification example. The superconducting coil 12 is connected to an external power supply 24 disposed outside the vacuum chamber 14 via the electric current introduction line 20. An exciting current is supplied from the external power supply 24 to the superconducting coil 12 through the electric current introduction line 20. The electric current introduction line 20 may include the feedthrough portion 20b and the high-temperature superconducting current lead 20d3, as in the above-described embodiment.

The superconducting coil 12 is divided into a plurality of (for example, N, N is any natural number) superconducting coil portions 12a_1 to 12a_N, and these superconducting coil portions 12a may be connected in series. The superconducting magnet device 10 includes a plurality of Joule heat generating elements 22, and each of the plurality of Joule heat generating elements 22 is connected in parallel to a corresponding superconducting coil portion 12a of the plurality of superconducting coil portions 12a. The high-temperature superconducting current lead 20d3 connects each Joule heat generating element 22 and a corresponding superconducting coil portion 12a. Compared to the non-divided coil configuration, such a divided coil configuration can reduce the voltage applied to both ends of the superconducting coil 12 when quenching occurs, which is particularly advantageous when the superconducting coil 12 has a large size.

Similarly to the above-described embodiment, the Joule heat generating element 22 is thermally coupled to the first cooling stage 16a of the cryocooler 16 and cooled to the first cooling temperature, and the superconducting coil 12 is thermally coupled to the second cooling stage 16b of the cryocooler 16 and cooled to a second cooling temperature. In FIG. 2, for convenience, a first portion cooled to the first cooling temperature is shown surrounded by a broken line 30, and a second portion cooled to the second cooling temperature is shown surrounded by a broken line 32. The heat generated by the Joule heat generating element 22 can be efficiently removed by the first cooling stage 16a, which is advantageous in shortening the time required for the superconducting magnet device 10 to recover from the quenching.

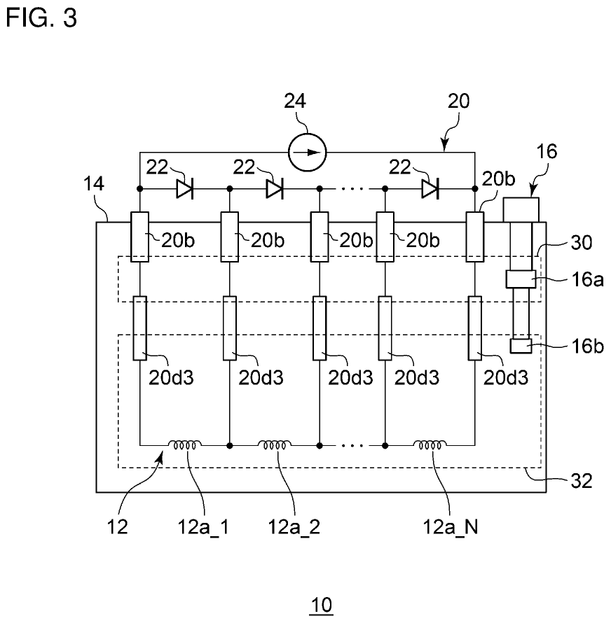

FIG. 3 is a diagram schematically showing a superconducting magnet device 10 according to a comparative example. As illustrated, it is also possible in principle to dispose the Joule heat generating element 22 in a surrounding environment outside the vacuum chamber 14. However, in that case, the number of electric current introduction lines 20 (for example, the feedthrough portion 20b) that need to be provided in the vacuum chamber 14 in order to connect the Joule heat generating element 22 and the superconducting coil 12 increases, and the structure becomes complicated. In addition, since the large number of the electric current introduction lines 20 also serve as a path for heat intrusion from the surrounding environment, input heat to the superconducting coil 12 increases. On the other hand, according to the embodiment, by disposing the Joule heat generating element 22 in the vacuum chamber 14, such disadvantages can be eliminated, which is advantageous.

The present invention has been described above based on the examples. It will be understood by those skilled in the art that the present invention is not limited to the above embodiments, various design changes can be made, various modification examples are possible, and such modification examples are also within the scope of the present invention. Various features described in relation to the certain embodiment are also applicable to other embodiments. A new embodiment resulting from combination has the effects of each of the combined embodiments.

The above-described embodiment has been described as an example of a case where the cryocooler 16 is a GM cryocooler, but the present invention is not limited thereto. In an embodiment, the cryocooler 16 may be a two-stage type cryocooler of another type having a first cooling stage 16a and a second cooling stage 16b, for example, a Solvay cryocooler, a Stirling cryocooler, a pulse tube cryocooler, or the like.

In FIG. 1, one cryocooler 16 is shown as an example. However, for example, in a case where the superconducting coil 12 has a large size, the superconducting magnet device 10 may include a plurality of cryocoolers 16 for cooling one same superconducting coil 12 as necessary.

In the above-described embodiment, the superconducting magnet device 10 is configured as a so-called conduction cooling type in which the superconducting coil 12 is directly cooled by the cryocooler 16, instead of as an immersion cooling type in which the superconducting coil 12 is immersed in a cryogenic liquid refrigerant such as liquid helium. However, the superconducting magnet device 10 may be an immersion cooling type. In this case, the superconducting coil 12 may be cooled by being immersed in a cryogenic liquid such as liquid helium, and the Joule heat generating element 22 may be cooled by using a refrigerant (for example, liquid nitrogen) having a higher boiling point. In this way, the Joule heat generating element 22 may be cooled to a cooling temperature higher than that of the superconducting coil 12 during the operation of the superconducting coil 12.

It should be understood that the invention is not limited to the above-described embodiment, but may be modified into various forms on the basis of the spirit of the invention. Additionally, the modifications are included in the scope of the invention.

What is claimed is:

1. A superconducting magnet device comprising:
a superconducting coil; and
a Joule heat generating element that is connected in parallel to the superconducting coil and is cooled to a cooling temperature higher than the superconducting coil during an operation of the superconducting coil.

2. The superconducting magnet device according to claim 1, further comprising:
a cryocooler including a first cooling stage that is thermally coupled to the Joule heat generating element and cooled to a first cooling temperature, and a second cooling stage that is thermally coupled to the superconducting coil and cooled to a second cooling temperature lower than the first cooling temperature.

3. The superconducting magnet device according to claim 1, wherein
the superconducting coil includes a plurality of superconducting coil portions connected in series to form the superconducting coil,
the superconducting magnet device includes a plurality of the Joule heat generating elements, and
each of the plurality of Joule heat generating elements is connected in parallel to a corresponding superconducting coil portion among the plurality of superconducting coil portions.

4. The superconducting magnet device according to claim 3, further comprising:
a high-temperature superconducting current lead that connects the Joule heat generating element and the corresponding superconducting coil portion.

5. The superconducting magnet device according to claim 1, wherein
the Joule heat generating element includes a non-linear resistor.
